(19) United States
(12) Patent Application Publication
(10) Pub. No.: US 2009/0268706 A1
(43) Pub. Date: Oct. 29, 2009

(54) OPTIMISED PACKET DATA TRANSMISSION PROTOCOL IN A COMMUNICATION SYSTEM EMPLOYING A TRANSMISSION WINDOW

(75) Inventors: Walter Featherstone, Swindon (GB); Colleen Cheung, Fleet (GB); Steven J. Simpson, Swindon (GB); Howard J. Thomas, Cirencester (GB)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 12/297,068

(22) PCT Filed: Mar. 30, 2007
(86) PCT No.: PCT/US07/65557

§ 371 Date: Oct. 14, 2008

(30) Foreign Application Priority Data
Apr. 18, 2006 (GB) 0607636.8

(51) Int. Cl. H04J 3/00

(52) U.S. Cl. 370/345

(57) ABSTRACT

A packet data transmission protocol that uses transmission windows includes a packet control unit (PCU) (4, 8) that transmits (100) blocks of data packets from a first transmission window. A user equipment (UE) (2) sends (102) a negative acknowledgement to the PCU if the packets are not received properly, whereupon the PCU construct (106) a dummy radio link control (RLC) block (60), including at least header information upon event of an established (104) trigger (60) event. The PCU sends (108) the dummy RLC block at a more robust coding rate to prevent a RLC stall condition.

### FIELD OF THE INVENTION

This invention relates to the transmission and retransmission of packet data, and in particular to a transmission protocol for packet data in a wireless communication system employing a transmission window.

### BACKGROUND OF THE INVENTION

The transmission of data, in the form of data packets, across a digital communication network is typically performed using a mechanism known as a protocol stack. Protocols are used to organise the transmission of data by means of a hierarchy of protocol layers, the protocol layers being considered collectively as a protocol stack. The hierarchy of layers typically extends from a physical layer (which dictates the manner in which individual bits are transmitted), up through to an application layer, which determines, for example, how high-level computer programs interact with each other.

One example of an intermediate layer of the protocol stack is a logical link control (LLC) layer, which controls the transmission of data across a single organisational link in the network. For example, in a cellular radio communication system according to the Universal Mobile Telephone Standard (UMTS), at the LLC layer a single organisational link exists between a Radio Network Controller (RNC) and a user equipment, usually a mobile station (MS) such as a mobile telephone, whereas in the physical layer the physical connection is implemented by a first physical link (Iub) from the RNC to an intermediate physical entity, namely a Node-B (UMTS terminology for a base transceiver station) and a second physical link (Uu) from the Node-B to the MS. In the above example, the RNC may be known as the Packet Control Unit (PCU) or transmission-end (Tx-end) of the link layer, and the MS as the receiver-end (Rx-end). The layers in the protocol stack can be operated independently of each other.

Within the LLC link layer, a mechanism called Automatic Repeat Request (ARQ) provides an error control mechanism for data transmission that allows the Rx-end to periodically advise the Tx-end as to whether data packets have been received without error or not. This allows the Tx-end to retransmit any packets that were transmitted in error in the previous period.

The message sent by the Rx-end is known as an acknowledgement/negative acknowledgement (ACK/NACK). The ACK/NACK message contains the ACK/NACK state of the previous transmitted packet data units (PDU), also termed data packets or blocks, sent to the Rx-end by the Tx-end.

On receiving the ACK/NACK message the Tx-end is able to retransmit those packets that were reported as being received in error (NACKed) by the Rx-end; typically the oldest NACKed PDU is retransmitted first. In this scenario several problems arise when attempting to transmit real-time (RT) services.

When an end-to-end (ETE) connection is established, certain quality of service (QoS) requirements are negotiated, for example the packet transfer delay, the guaranteed bit rate, and priority, amongst others. Typically the transfer delay is defined with respect to delivery of the transport layer protocol packets such as transmission control protocol (TCP) segments. When the network has several links, the delay maybe further broken down to be specified for each link, such as when a wireless radio access network (RAN) is involved, a particular proportion of the delay maybe set aside for the air interface. In order to meet the overall ETE QoS requirements each link is required to meet its individual QoS requirements.

Transfer delay for real time (RT) services, e.g. voice and video, is one of that service's critical QoS requirements, since support for a continuous stream of data with low delay variation is essential for supporting a usable service. Typically a transport protocol such as User Datagram Protocol (UDP) is used, where retransmissions are not supported. This is because there is insufficient time to retransmit the packets at the transport layer and therefore such services must have a degree of packet error or loss tolerance. The same is not true for non-RT (NRT) services, where all data being transferred is required. Therefore protocols supporting retransmissions are typically used for such services, for example TCP.

At the air interface, connections are assigned either circuit switched (CS) or packet switched (PS) connections. The use of PS connections can make more efficient use of the air interface due to the multiplexing gains that can be afforded, rather than tying up dedicated CS resource. Typically NRT services such as web browsing or FTP file transfer that can tolerate higher delay variation are mapped to PS bearers. However, there is a drive to map more RT services to PS bearers, for example voice over IP (VoIP), push to talk over cellular (PoC) and even video. Therefore there is a need to support QoS guarantees in the PS domain.

Wireless networks are prone to a far higher error rate than their wire line counterparts. In fact, losses in wire-line networks are usually due to buffer overflows at its nodes rather than actual decoding errors, i.e. congestion. The result is that the radio link control (RLC) protocol in the PS domain, used to transport the higher layer packets over the air interface, is usually run in acknowledged mode (AM) in the user plane.

Retransmissions can be tolerated so long as the QoS delay budget is not exceeded.

Firstly, it should be noted that these issues are applicable to any transmission protocol employing a transmission window, e.g. radio link control (RLC) and TCP. The application to GPRS is particularly relevant due to the current lack of support in mobiles for separate RLC connections for RT and NRT services, hence the necessity to support both under one Temporary Block Flow (TBF). As mentioned previously the typical procedure is to support RT services under protocols where retransmissions are not supported, however under situations where a mobile's battery power needs to be conserved, the maintenance of multiple TBFs may be considered inefficient. Under these situations both RT and NRT must be transmitted using protocols that maintain the reliability expected by NRT traffic yet allow the RT services to meet their transfer delay guarantees.

One problem with retransmissions is that they take time due to the round trip time between transmitting and receiving the corresponding acknowledgement status. Even with mechanisms implemented to reduce the probability of the QoS requirements not being met, there will always remain a probability that the retransmission rate will be too high. In addition, due to the finite size of the transmission window the higher layer packets behind the current packet will be held up until the current packet is cleared from the transmission window. This is particularly problematic in GPRS networks due to the fact that 3GPP Specifications only allow for any retransmission of RLC blocks in the original coding scheme (retransmitting the RLC blocks in more robust coding schemes would require more RLC blocks to be transmitted and this would not be recognised by the RLC entity in the mobile since they would exceed the window size) which means that if channel conditions degrade the error rate experienced on retransmissions may be even higher than was the case for the original transmission. The 3GPP GPRS Specification does not provide a method for advancing the transmission window, other than providing a mechanism for the receiving entity to indicate to the transmitting entity that a stall is being experienced (an indication bit is provided in the acknowledgement header). However, it is more than likely that the transmission window will have already stalled before that information is obtained. All the transmitting entity can do is to retransmit negatively acknowledged blocks or retransmit those blocks for which no acknowledgement has been received.

An additional problem with retransmissions is that blocks of new data in the next transmission window can only be transmitted once the oldest block in the existing window has been positively acknowledged. Therefore if this block is not acknowledged a point is reach when no new blocks can be transmitted, because they would be outside the transmission window. This is referred to as a stall condition. The result is that any buffered blocks will be held up (since they can not jump the queue) and therefore experience a lengthening queuing delay. This further increases the likelihood that the QoS TD requirements of not only those higher layer packets are jeopardised, but also those for the whole session.

Moreover, in situations where RT and NRT sessions are multiplexed over the same air interface connection, it is possible that a RT LLC frame becomes queued behind a NRT LLC frame at the RLC. Currently there is no known way of prematurely terminating transmission the NRT LLC in order to increase the probability of meeting the QoS guarantees for the RT session.

Thus there exists a need in the field of the present invention to address the drawbacks of transmission protocols employing a transmission window and in doing so increase the likelihood of meeting QoS guarantees.

### STATEMENT OF INVENTION

Accordingly, the Invention seeks to preferably mitigate, alleviate or eliminate one or more of the above mentioned disadvantages singly or in any combination.

In a first aspect, the present invention provides a method of a packet data transmission protocol, as claimed in claim 1.

In a second aspect, the present invention provides an apparatus for a packet data transmission protocol, as claimed in claim 8.

In a third aspect, the present invention provides a system for a packet data transmission protocol, as claimed in claim 15.

In a fourth aspect, the present invention provides a storage medium, as claimed in claim 23.

Further aspects are as claimed in the dependent claims.

According to the invention, to prevent a stalling condition, a dummy RLC block including at least header information is sent as a re-transmitted block at a lower coding rate in order to improve the chances of a user equipment accepting new blocks of data. Although the LLC layer will invalid date the block, this is better than a stall condition inasmuch as the LLC layer has alternative means of recovery.

### BRIEF DESCRIPTION OF THE DRAWINGS

Embodiments of the present invention will now be described, by way of example only, with reference to the accompanying drawings, in which:

FIG. 1 is a schematic illustration of transmission and re-transmission of data packets performed in accordance with the prior art in a cellular communication system;

FIG. 2 is a schematic illustration of protocol layers of a protocol stack in an embodiment of the present invention;

FIG. 3 is a schematic illustration of the protocol, in accordance with the present invention; and

FIG. 4 is a flowchart showing process steps employed in an embodiment of the present invention.

### DESCRIPTION OF PREFERRED EMBODIMENTS

The following description focuses on embodiments of the invention applicable to a cellular communication system providing real-time services utilizing GPRS. However, it will be appreciated that the invention is not limited to this application but may be applied to many other cellular communication systems utilizing services that may be adversely affected by transmission delays.

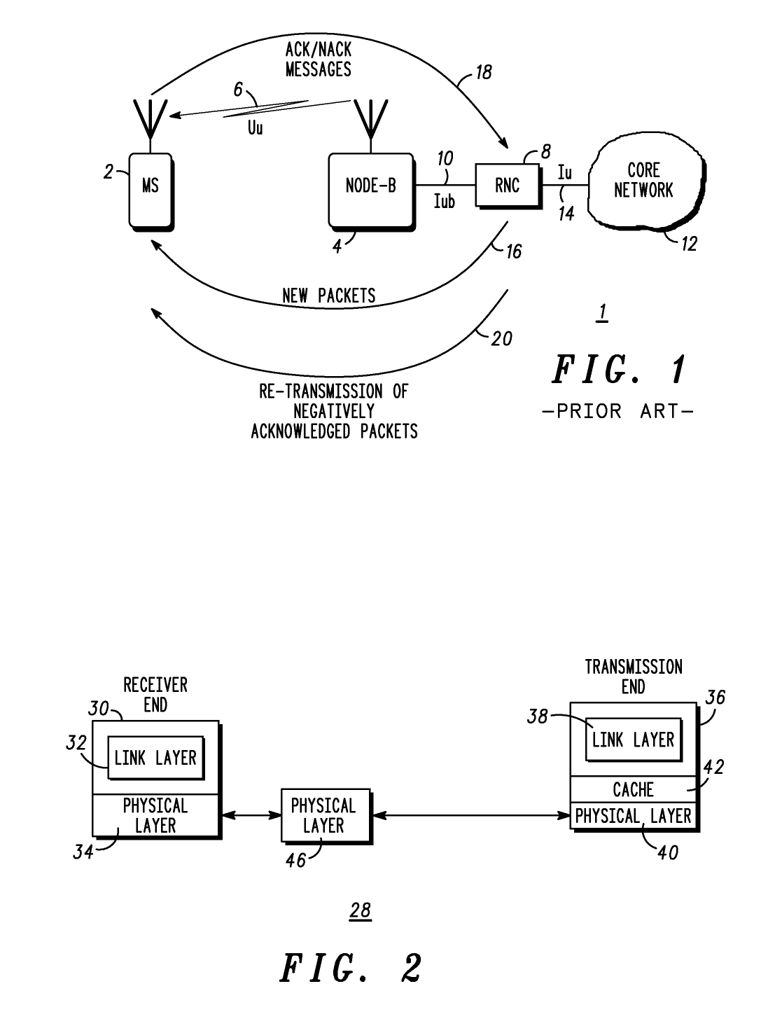

In general, this invention may be applied to a cellular communication system according to the Universal Mobile Telephone Standard (UMTS). The parts of such a communication system 1 which are helpful for understanding this embodiment are illustrated schematically in FIG. 1, for example. A user equipment such as mobile station (MS) 2, for use by an end-user, is coupled with a base transceiver station, known in UMTS as a Node-B, 4, via a radio link 6 operating according to the UMTS-specified Uu interface. The Node-B 4 is coupled to a Radio Network Controller (RNC) 8 via a physical link (e.g. a landline) 10 operating according the UMTS-specified Iub interface. The RNC 8 is coupled to a core network 12, e.g. the Internet, via a physical link (e.g. a landline) 14 operating according to the UMTS-specified Iu interface.

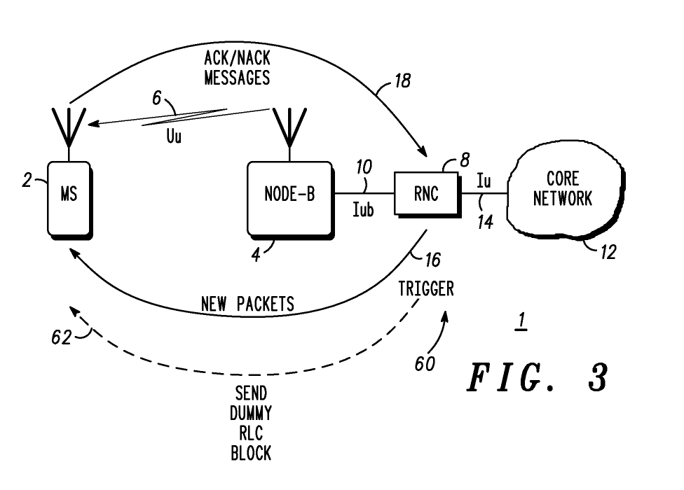

This embodiment relates to data packets being sent from a packet control unit (PCU), such as RNC 8, to the MS 2, and as such the PCU represents the transmit-end of the LLC layer under consideration, and the MS 2 represents the receive-end of the link layer (see FIG. 2 for example). The corresponding physical layer from the RNC 8 to the MS 2 is implemented in the MS 2 and the Node-B 4, where the Node-B forms an intermediate physical entity of the physical layer between the Ms 2 and the RNC 8.

The RNC 8 implementing the transit end link layer is connected to the Node-B 4 implementing the transmit end of the physical layer by a landline 10. FIG. 1 thus schematically shows original i.e. new blocks of data packets 16 being sent from the RNC 8 to the MS 2.

For each data packet, the MS 2 sends back an ACK/NACK message 18 to the RNC, i.e. an acknowledgement (in the case of proper receipt) or a negative acknowledgement (in the case of improper receipt). The ARQ mechanism can be operated from the RNC 8, or alternatively the Node-B 4, by organisationally using only the link layer, in the radio link control (RLC) layer protocol. The RNC or Node-B stores packets in a cache, for a given limited time period after their reception by the Physical Layer, such that negatively acknowledged data packets 20 can be re-transmitted to the MS 2.

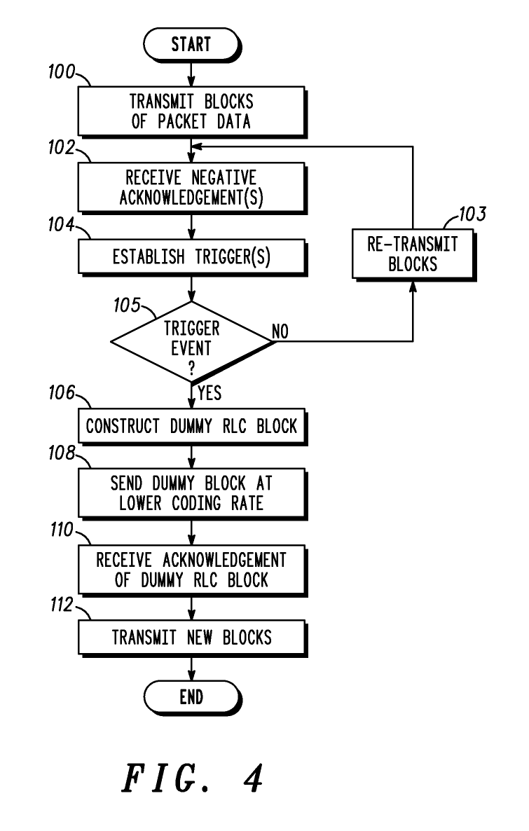

FIG. 2 shows a protocol stack arrangement 28 (for the system of FIG. 4) adapted to perform transmission of packet data blocks, in accordance with the present invention. The RX-end 30 (corresponding to the MS 2) of the protocol stack contains a link layer 32 and a physical layer 34. The Tx-end 36 (corresponding to the RNC 8) of the protocol stack contains a LLC link layer 38. The transmit end physical layer is implemented in an intermediate physical entity, namely the Node-B 4, and this adds to the protocol stack the additional physical layer part 46, as shown in FIG. 2. In this embodiment, there is additionally a Tx-end link layer cache 42 associated with the physical layer, which can be located in the Node-B or the RNC (as shown).

An apparatus for implementing the above arrangement, and performing the method steps to be described later below, is provided by adapting conventional apparatus and/or providing additional modules. In particular, additional apparatus may be provided at the intermediate physical entity, i.e. the Node-B 4. The apparatus may be in the form of hardware, firmware, or software, or a combination of these. The apparatus may comprise one or more processors, for implementing instructions and using data stored in a storage medium such as a computer disk or PROM.

FIG. 3 schematically illustrates an apparatus and communication system adapted to operate according to the present embodiment. As before, original i.e. new data packets 16 are sent from a packet control unit (PCU) transmitting entity (e.g. Node-B 4 or RNC 8) to the user equipment (UE) MS 2. Also as before, for each data packet, the MS 2 sends back an ACK/NACK message 18 to the PCU, i.e. an acknowledgement (in the case of proper receipt) or a negative acknowledgement (in the case of improper receipt). However, in contrast to the FIG. 1 procedure, the present invention transmits a dummy data packet (i.e. RLC) block 62, with at least a header identification, upon a trigger event 60.

In accordance with the present invention, the transmitting entity (e.g. in the Packet Control Unit (PCU) comprising either the Node-B or RNC) replaces erroneous blocks requiring retransmission with a dummy block containing only the pertinent header information (at a minimum), when certain trigger conditions are met. In the case of GPRS, the dummy block is encoded in a more robust (i.e. lower) coding scheme, and preferably the most robust coding scheme. In the case of TCP, it is suggested that payload is reduced to a minimum. In either case, the result is the advancement to the next transmission window, thereby removing any stall condition (reactively) or reducing the probability of stall (proactively).

In the case of TCP, this is achieved since the transmission delay time of a shorter packet will be lower. For GPRS this is achieved since the more robust coding scheme has a higher probability of successful transmission. The present invention is applicable to any GPRS temporary block flow (TBF), regardless of whether RT, NRT or a combination of both session types is being transported. The “meaningless” information in the dummy block would be passed to the higher LLC layers when reconstructing the higher layer PDU (LLC frame in the case of GPRS).

In practice, the PCU will send a dummy RLC block at a lower coding rate with a minimum of at least the proper header ID. This is because a lower coding rate would produce a larger code length at the lower code rate, which could not be accommodated into the timing window. Therefore only the header can be sent (and any other data as long as it is known that the data will fit into the RLC time. Upon receipt of this dummy block, the MS will know to switch to the new, more robust coding scheme to accept new RLC blocks. The dummy block will be passed up to the LLC layer of the MS, which will determine that the block is invalid and discard the block. Fortunately, the LLC layer (32 of FIG. 2) operates separately from the physical layer (34 of FIG. 2), and the physical layers will proceed with the download of new blocks at the new rate, thereby preventing the RLC stall.

The remainder of the description is biased towards a GPRS system, but the basic principles are applicable to any lossless transmission protocol.

For GPRS the dummy block would be constructed using the same RLC block ID, such that if the block is received without error (which is very likely since a more robust coding scheme is being used) the receiving entity is effectively “tricked” at the RLC layer into believing that the actual information block has been received correctly. In addition, the dummy RLC block would be constructed such that the Length Indicator field would indicate precisely the length of the RLC data field containing the (remainder of the) supposed LLC PDU for the coding scheme at which the dummy block is to be transmitted. Alternatively the Length Indicator would be set to 0 to indicate that the LLC PDU is incompletely transmitted by the RLC block. Another embodiment would be to encode the original RLC block information in the more robust coding scheme, truncating the LLC PDU where there is insufficient space in the new RLC block (this is particular beneficial when information from more than one LLC frame is contained within the RLC block, since then only one LLC frame maybe impacted).

The reconstruction of the LLC PDU with the information contained within the dummy block would result in an Invalid LLC frame in accordance with the following criteria specified in 3GPP TS 44.064 clause 5.8:
1. The LLC frame contains fewer octets than necessary to include the address field, control field, information field and Frame Check Sequence (FCS) field necessary to constitute a complete frame according to the contents of the control field.
2. The LLC frame contains an FCS error.

Invalid LLC frames are discarded without notification to the sender. No further action is taken as a result of that frame.

Effectively discarding RLC PDUS, and therefore corrupting the LLC frame being transported resulting in the LLC frame being discarded, is preferable to jeopardising the QoS TD requirements of the whole session. RT can tolerate a certain error rate and in fact the service data unit (SDU) error ratio is also negotiated as part of the QoS guarantees for the Packet Flow Context (PFC). Also, NRT services generally employ a higher layer transmission protocol, such as TCP, to recover such errors (through retransmission).

In accordance with the present invention, there are number of conditions that could trigger the transmission of a dummy RLC block. Examples include, but are not limited to:
1) When the coding scheme for RLC blocks in the next window is lower than the coding scheme used for the RLC blocks in the current window.
2) When the RLC window stall has occurred for more than a certain period of time as determined by a timer set when the first retransmission is required and resetting when a Packet Polling Request receives no further requests for the RLC block. Upon the timer expiry, the dummy RLC block would be sent.
3) When it is determined that the stall condition is close, e.g. the number of new blocks in the transmission window reduces below a certain number/percentage of total size due to the normal operating procedure of discarding of packets.
4) When transmission of a RT LLC frame is queued behind a NRT LLC frame, then this approach could be adopted for RLC retransmissions of the NRT LLC frame to clear that frame from the RLC window.
5) If it is predicted that the TD requirements of the current RT LLC frame cannot be met then there is no point causing further delay through erroneous retransmissions and therefore retransmissions could be limited to the most robust coding scheme to clear that LLC frame. This would reduce the likelihood of later RT LLC frames not meeting there TD requirements.

In a specific implementation these and other options could be enabled or disabled.

A possible side effect of this technique is on the perceived BLER; because the error rate could be seen to improve as a result of transmitting block in a more robust coding scheme. The problem is that the BLER estimate is generally used as part of the link adaptation (coding scheme selection) algorithm and therefore an optimistic BLER estimate could cause the link adaptation algorithm to increase the selected coding scheme incorrectly. However, this can be overcome in GPRS, by having the receiving entity provide a BLER bitmap report on demand (report on the error status of each block sent). Since the transmitting entity knows which blocks were forced down to a lower coding scheme, those could be excluded from the BLER statistic.

Referring to the flowchart of FIG. 3, the present invention provides a method whereby only the header information (as a minimum) for a transmission block retransmission is resent (in order to enable transmission window advancement for lossless transmission protocols) when it is deemed that the QoS targets of the higher layer packets or the data transfer as a whole are in jeopardy, measured through parameters such as transfer delay or closeness to stalling of the transmission window.

A first step 100 includes transmitting blocks of data packets from a first transmission window, as is known in the art.

A next step 102 includes receiving, for the transmitted data packets, at least one negative acknowledgement (NACK). The NACK is indicative of an existing or impending stall condition for that transmission window.

A next step 104 includes establishing a trigger for the protocol, wherein the following steps occur only upon event of the trigger. This step can occur anywhere in the method. The trigger events themselves have been described above. If none of the trigger events are met 105, the process continues with re-transmission of blocks 103, as is known in the art.

Upon a trigger event 105, a next step 106 includes constructing a dummy data packet (i.e. radio link control (RLC)) block, including at least a header identification.

A next step 108 includes sending the dummy RLC block at a more robust coding rate than that used for the originally transmitted data packets.

A next step 110 includes receiving an acknowledgement for the dummy RLC block, wherein the user equipment is reconfigured to accept packets at the new coding rate.

A next step 112 includes transmitting new blocks of data packets from the next transmission window at the new coding rate, thereby preventing a stall condition for the RLC blocks, as detailed previously.

It is within the contemplation of the invention that, in addition to GPRS systems, any other wireless networks utilizing transmission windows employing lossless transmission protocols, can benefit from the techniques described herein. Such protocols include RLC and TCP.

It will be understood that the present invention provides the following advantages:
(i) With respect to GPRS the invention enables the discard of an LLC frame in order to surmount the problem of interminable RLC stalls on GPRS via the transmission of an RLC block on a more robust coding scheme mimicking the identity of the RLC block to be retransmitted. Currently there is no known method within the GPRS Specifications to achieve this;
(ii) Prior to this invention GPRS RLC block retransmissions had to occur on the same coding scheme and error protection. This caused RLC window stalls in particular when radio link conditions deteriorated in the time period between the original transmission and the retransmission. This could occur quite often since retransmissions are usually incurred precisely when radio conditions deteriorated, and while radio conditions remained poor, the likelihood of the retransmission being successful is low;
(iii) Similarly for TCP, where in every packet a TCP end-point advertises the amount of window space currently available, no data can be sent if that window size, minus any unacknowledged data that has already been sent to that system, is zero; and
(iv) Prior to this invention TCP retransmissions would stall when the TCP window size was too small to allow the packet to traverse the link and the acknowledgement to be sent and received in time for the next packet to be sent after the window is full.

This roundtrip time (RTT) is affected by the TCP packet size as well as the number of hops (and the queue delays in each hop) the packet has to traverse. Reducing the TCP packet size thus reduces the RTT hence allowing more packets to be sent for a given window size.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term “comprising” does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method for a packet data transmission protocol that uses transmission windows, the method comprising the steps of:
transmitting blocks of data packets from a first transmission window;
receiving, for the transmitted data packets, at least one negative acknowledgement;
constructing a dummy data packet block, including at least header information;
sending the dummy block at a more robust coding rate than that used for the originally transmitted data packets;
receiving an acknowledgement for the dummy block; and
transmitting new blocks of data packets from the next transmission window.

2. A method according to claim 1, wherein the dummy data packet block is a dummy radio link control (RLC) block.

3. A method according to claim 1, further comprising the step of establishing a trigger for the protocol, wherein the constructing and sending steps only occur upon event of the trigger.

4. A method according to claim 3, wherein the trigger comprises a condition selected from the group of; when the received negative acknowledgements cause a RLC window stall that has occurred for more than a predetermined period of time, when the number of new blocks in the transmission window falls below a predetermined limit, indicating an impending stall condition, when transmission of a real-time (RT) logical link control (LLC) frame is queued behind a non-real time (NRT) LLC frame, and when it is determined that a time delay requirement of the current real-time (RT) logical link control (LLC) frame cannot be met.

5. An apparatus for a packet data transmission protocol that uses transmission windows, the apparatus comprising:
means for transmitting blocks of data packets from a first transmission window;
means for receiving, for the transmitted data packets, at least one negative acknowledgement;
means for constructing a dummy data packet block, including at least header information;
means for sending the dummy block at a more robust coding rate than that used for the originally transmitted data packets;
means for receiving an acknowledgement for the dummy block; and
means for transmitting new blocks of data packets from the next transmission window.

6. An apparatus according to claim 5, wherein the dummy data packet block is a dummy radio link control (RLC) block.

7. An apparatus according to claim 5, further comprising means for establishing a trigger for the protocol, wherein the protocol only occurs upon event of the trigger.

8. An apparatus according to claim 7, wherein the trigger comprises one of the group of; a condition of when the coding scheme for RLC blocks in the next window is more robust than the coding scheme used for the RLC blocks in the current window, a condition of when the received negative acknowledgements cause a RLC window stall that has occurred for more than a predetermined period of time, a condition of when the number of new blocks in the transmission window falls below a predetermined limit, indicating an impending stall condition, a condition of when transmission of a real-time (RT) logical link control (LLC) frame is queued behind a non-real time (NRT) LLC frame, and a condition of when it is determined that a time delay requirement of the current real-time (RT) logical link control (LLC) frame cannot be met.

9. A system for a packet data transmission protocol that uses transmission windows, the system comprising:
a packet control unit for sending blocks of data packets from a first transmission window; and
a user equipment for receiving the block of data packets and informing the packet control unit about said reception, wherein
if the user equipment sends at least one negative acknowledgement for the transmitted data packets, the packet control unit constructs a dummy data packet block, including at least header information, and sends the dummy block at a more robust coding rate than that used for the originally transmitted data packets to the user equipment.

10. A system according to claim 9, further comprising a trigger for the protocol, wherein the protocol only occurs upon event of the trigger.
